(19) United States
(12) Patent Application Publication
(10) Pub. No.: US 2022/0003445 A1
(43) Pub. Date: Jan. 6, 2022

(54) COOLING DEVICE FOR SUPPORTING ENERGY SAVING AND OPERATING METHOD THEREFOR

(71) Applicant: Euntae KIM, Jeju-si, Jeju-do (KR)

(72) Inventor: Euntae KIM, Jeju-si, Jeju-do (KR)

(21) Appl. No.: 17/292,007

(22) PCT Filed: Nov. 26, 2018
(86) PCT No.: PCT/KR2018/014597

§ 371 Date: May 7, 2021

(30) Foreign Application Priority Data
Nov. 12, 2018 (KR) 10-2018-0138463

(51) Int. Cl. F24F 11/46; F24F 11/72; F24F 11/88

(52) U.S. Cl. CPC F24F 11/46; F24F 11/88; F24F 11/72

(57) ABSTRACT

A cooling device includes at least one fan; at least one air conditioner; a case covering at least a part of the fan and the air conditioner; and a control unit for controlling operation of the fan and the air conditioner, wherein the control unit controls the at least one fan and the at least one air conditioner to be operated simultaneously or partially, according to a difference between a current surrounding state value and a setting value.

### TECHNICAL FIELD

The present invention relates to a cooling system, and more particularly, to a cooling device for supporting energy saving capable of supporting adequate cooling while saving energy by effectively operating a cooling device according to environment, and an operating method thereof.

### BACKGROUND ART

A cooling device is a system that cools air and then lowers a temperature of a designated space using the cool air. In this case, since ambient air at a certain temperature or more is suctioned and cooled, there is a problem that high power is consumed to cool the air suctioned into the cooling device.

In addition, since the air exhausted from the cooling device is heavier than the surrounding hot air, diffusion is delayed or a diffusion range is small. Accordingly, even when a cooling temperature of the cooling device is lowered, some of the cool air remains, and thus, there is a problem that a cooling effect that a user feels through his or her skin is small.

Meanwhile, conventionally, devices capable of simultaneously cooling and heating by configuring a cooling device and a heating device as a single device are being developed and sold. However, since both a cooling structure and a heating structure should be disposed in one device, a volume increases, and there is a problem that it is difficult to maximize efficiency of cooling or heating. Accordingly, in recent years, there is a demand for a device having good power efficiency while being provided for any one purpose, that is, cooling or heating.

### DISCLOSURE

### Technical Problem

The present invention is directed to providing a cooling device for supporting energy saving which includes a plurality of fans and at least one air conditioner in one case and which adaptively operates at least one of the plurality of fans and the air conditioner according the surrounding environment to increase power efficiency, reduce a time to reach a target setting value, and improve sensation of a cooling effect, and an operation method thereof.

However, the object of the present invention is not limited to the above object, and other objects not mentioned will be clearly understood from the following description.

### Technical Solution

One aspect of the present invention provides a cooling device including a case, a first fan and a second fan at least partially disposed in the case, an air conditioner disposed inside the case, relays configured to individually or simultaneously turn the first fan, the second fan, and the air conditioner on or off, an input device configured to generate an input signal related to operations of the first fan, the second fan, and the air conditioner, and a control unit configured to control the relays. The relays include a first relay connected to an external power source, a second relay disposed to simultaneously or selectively control the fans and the air conditioner, a third relay configured to independently control the first fan, a fourth relay configured to independently control the second fan, and a fifth relay configured to independently control the air conditioner.

Another aspect of the present invention provides a cooling device including a case, at least one fan at least partially disposed in the case, an air conditioner disposed inside the case, an input device configured to generate an input signal related to operations of the at least one fan and the air conditioner, a sensor circuit configured to detect a surrounding environment, and a control unit configured to control the operations of the at least one fan and the air conditioner, in which the control unit simultaneously operates the at least one fan and the air conditioner or selectively operates some of the fans and the air conditioner according to a difference between a current surrounding state value obtained based on the sensor circuit and a setting value set in advance.

The case may include a device placement hole in which a head including a blade of the fan is disposed, and the cooling device may further include a movement module configured to move the fan so that at least a portion of the head of the fan protrudes or is drawn into the case through the device placement hole.

The movement module may operate the fan so that the head of the fan rotates within a specified rotation angle range in at least one direction of upward, downward, right, and left directions or the fan linearly moves in a vertical direction.

The case may further include a cool air regulating hole through which cool air generated by the air conditioner is exhausted to an outside of the case or flows inside the case according to a control.

The cooling device may further include at least one pipe through which cool air generated by the air conditioner moves to a region in which the at least one fan is disposed.

Still another aspect of the present invention provides an operation method of a cooling device including at least one fan at least partially disposed in a case and an air conditioner disposed inside the case, the operation method includes receiving an input signal related to operations of the at least one fan and the air conditioner, checking a current surrounding state value based on a sensor unit, and simultaneously or partially operating the at least one fan and the air conditioner according to a difference between the checked current surrounding state value and a setting value set in advance.

The operating may include simultaneously operating the at least one fan and the air conditioner when the difference between the current surrounding state value and the setting value set in advance is a first size.

The operating may include operating some of the at least one fan and the air conditioner when the difference between the current surrounding state value and the setting value set in advance is a second size smaller than the first size.

The operating may include controlling outputs of the at least one fan and the air conditioner to be smaller than before when the difference between the current surrounding state value obtained based on the sensor circuit and the setting value set in advance is the second size smaller than the first size.

The operation method may further include at least one of operating devices of which a number is smaller than the number of devices including the at least one fan and the air conditioner and operating outputs of the devices including the at least one fan and the air conditioner with a smaller output than before when a surrounding state value is changed according to operations of the least one fan and the air conditioner.

### Advantageous Effects

According to the present invention, in a cooling device and an operating method thereof of the present invention, depending on the surrounding environment, it is possible to minimize an amount of power used while minimizing a time to reach a setting value, and thus, it is possible to maximize cooling effects as well as energy saving.

In addition, it is possible to adaptively maintain a surrounding environment state corresponding to the setting value of the present invention based on the minimum power operation.

Moreover, various effects other than the above-described effects may be directly or implicitly disclosed in a detailed description according to embodiments of the present invention to be described below.

### DESCRIPTION OF DRAWINGS

FIG. 1 is a view illustrating an example of an exterior of a cooling device according to one embodiment of the present invention.

FIG. 2 is a view illustrating an example of an internal structure of the cooling device according to one embodiment of the present invention.

FIG. 3 is a diagram illustrating an example of a power control structure of the cooling device according to one embodiment of the present invention.

FIG. 4 is a diagram illustrating an example of a configuration of the cooling device according to one embodiment of the present invention.

FIG. 5 is a diagram illustrating an example of a cooling device operating method according to one embodiment of the present invention.

### MODES OF THE INVENTION

In order to clarify features and advantages of solving means of the present invention, the present invention will be described in more detail with reference to specific embodiments of the present invention illustrated in the accompanying drawings.

However, in the following description and the accompanying drawings, detailed descriptions of known functions or configurations that may obscure a gist of the present invention will be omitted. In addition, it should be noted that the same components are denoted by the same reference numerals as much as possible throughout the drawings.

Terms or words used in the following description and drawings should not be construed as limited to their usual or dictionary meanings, and should be interpreted as meanings and concepts corresponding to a technical idea of the present invention based on a principle that the inventor can appropriately define concepts of terms to describe his or her invention in the best way. Therefore, configurations illustrated in embodiments and drawings described in the present specification are only exemplary embodiments of the present invention and do not represent all technical ideas of the present invention, and thus, it should be understood that there may be various equivalents and modified examples that can be substituted for the configurations at the time of the present application.

In addition, terms including ordinal numbers such as first and second are used to describe various elements and are only used for a purpose of distinguishing one component from other components and are not used to limit the above components. For example, without departing from a scope of the present invention, a second component may be referred to as a first component, and similarly, the first component may be referred to as the second component.

In addition, the terms used in the present specification are used only to describe specific embodiments and are not intended to limit the present invention. Singular expressions include plural expressions unless a context clearly indicates otherwise. In addition, terms such as “comprises” or “have” described in the present specification are intended to designate the presence of features, numbers, steps, actions, components, parts, or a combination thereof described in the specification, and it is to be understood that the terms do not preclude possibility of the presence or addition of one or more other features or numbers, steps, actions, components, parts, or combinations thereof.

In addition, terms such as “unit,” “group,” and “module” described in the specification mean a unit that processes at least one function or operation, which may be implemented by hardware or software, or a combination of hardware and software. In addition, “a or an,” “one,” “the,” and similar related words may be used as a sense including both singular and plural unless otherwise indicated in the specification or clearly contradicted by a context in a context (particularly, in contexts of the following claims) of describing the present invention.

In addition to the above-described terms, specific terms used in the following description are provided to aid in understanding the present invention, and the use of these specific terms may be changed to other forms within a scope which does not depart from a technical idea of the present invention.

In addition, embodiments within the scope of the present invention include a computer-readable medium having or transmitting computer-executable instructions or a data structure stored in the computer-readable medium. The computer-readable medium may be any available medium accessible by a general purpose or special purpose computer system. For example, the computer-readable medium may include a Random Access Memory (RAM), a Read Only Memory (ROM), a Erasable Programmable Read Only Memory (EPROM), a Compact Disc Read Only Memory (CD-ROM), other optical disk storage devices, a magnetic disk storage device, other magnetic storage devices, or a physical storage medium such as any other medium which can be used to store or transmit computer-executable instructions, computer-readable instructions, or a predetermined program code means in the form of a data structure and can be accessed by a general purpose or special purpose computer system but is not limited thereto.

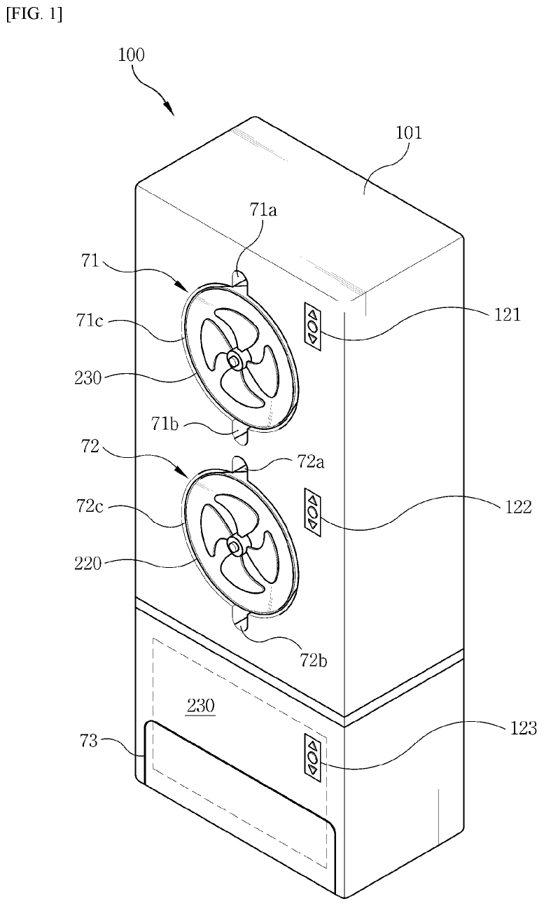

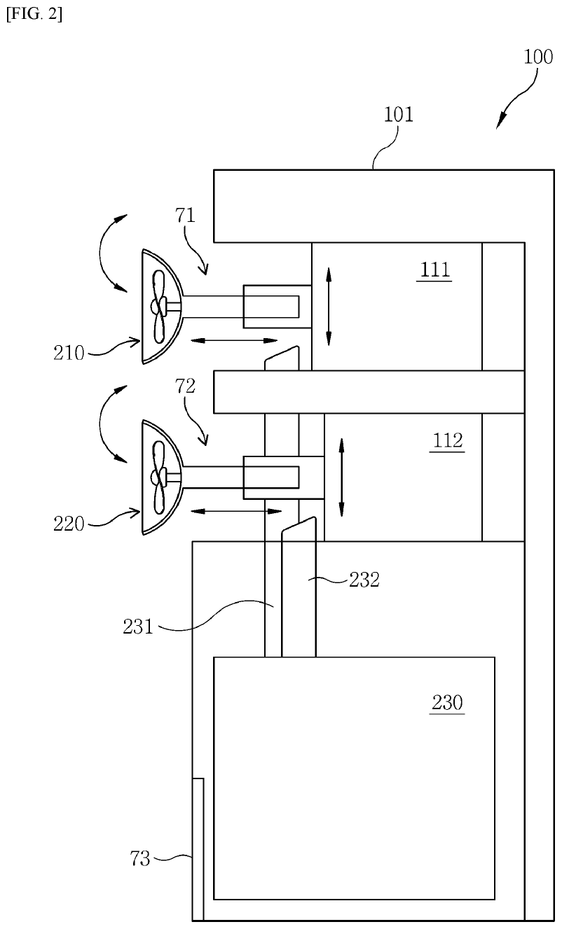

FIG. 1 is a view illustrating an example of an exterior of a cooling device according to one embodiment of the present invention, and FIG. 2 is a view illustrating an example of an internal structure of the cooling device according to one embodiment of the present invention.

Referring to FIGS. 1 and 2, a cooling device 100 according to one embodiment of the present invention includes a case 101, a first fan 210 and a second fan 220 which are at least partially mounted inside the case 101, and an air conditioner 230 and may include a first input device 121 for controlling an operation of the first fan 210, a second input device 122 for controlling the second fan 220, and a third input device 123 for controlling the air conditioner 230. The first input device 121 may include at least one button or a touch panel for turning on/off the first fan 210 and adjusting a setting value. Similarly, the second input device 122 may include at least one button or a touch panel for turning on/off the second fan 220 and adjusting a setting value. In addition, the third input device 123 may include at least one button or a touch panel for turning on/off the air conditioner 230 and adjusting a setting value.

The case 101 may have a space having a predetermined size therein so that at least a portion of each of the first fan 210, the second fan 220, and the air conditioner 230 may be housed. For example, the case 101 includes a first area in which the first fan 210 is disposed, a second area in which the second fan 220 is disposed, and a third area in which the air conditioner 230 is disposed and may include plates (or shelves) which may partition each area. The plate may include a hole through which guide pipes 231 and 232, which are provided to guide cool air generated by the air conditioner 230 to the first region and the second region, pass. At least a portion of the case 101 may be formed of a plastic material, or at least a portion thereof may be formed of a metal material. Alternatively, an inside of the case 101 may be formed of a plastic material and a surface thereof may be coated with a metal material, or the inside of the case 101 may be formed of a metal material and the surface thereof may be formed of a plastic material. In the illustrated drawings, in the case 101, an inside of a rectangular parallelepiped is empty, but the present invention is not limited thereto. For example, the case 101 may adopt any shape as long as the case 101 includes a space in which the first fan 210, the second fan 220, and the air conditioner 230 may be disposed and has a structure in which wind generated by the first fan 210 and the second fan 220 may be discharged to the outside. For example, at least a portion of the case 101 may have a curved surface or at least a portion of the case 101 have a flat surface.

The case 101 may include a first device placement hole 71 in which the first fan 210 is disposed, the second device placement hole 72 in which the second fan 220 is disposed, and a cool air regulating hole 73 through which cool air generated by the air conditioner 230 is exhausted or moved into the case 101.

The first device placement hole 71 may be disposed in one side of the case 101 so that wind generated by the first fan 210 may be discharged to the outside. Alternatively, the first device placement hole 71 may serve as a passage along which at least a portion of a head including a fan in a configuration of the first fan 210 may be drawn outward or may be introduced to the inside. The first device placement hole 71 may include a first exhaust/movement hole 71c provided so that the head of the first fan 210 may move forward or rearward or wind generated by the first fan 210 seated therein is discharged to the outside, a first upward movement hole 71a provided so that the first fan 210 may move upward, and a first downward movement hole 71b provided so that the first fan 210 may move downward. The first upward movement hole 71a may be formed to extend upward from the first exhaust/movement hole 71c. The first downward movement hole 71b may be formed to extend downward from the first exhaust/movement hole 71c. When the first fan 210 is drawn outward through the first exhaust/movement hole 71c and then moves upward or downward, a support for supporting the fan of the first fan 210 may move to the first upward movement hole 71a or the first downward movement hole 71b to limit a vertical movement of the first fan 210.

The second device placement hole 72 may be disposed in one side of the case 101, for example, below the first device placement hole 71 so that wind generated by the second fan 220 may be exhausted to the outside. Alternatively, the second device placement hole 72 may serve as a passage along which at least a portion of a head including a fan in a configuration of the second fan 220 may be drawn outward or may be introduced inside. The second device placement hole 72 may include a second exhaust/movement hole 72c provided so that the head of the second fan 220 may move forward or rearward or wind generated by the second fan 220 seated therein is discharged to the outside, a second upward movement hole 72a provided so that the second fan 220 may move upward, and a second downward movement hole 72b provided so that the second fan 220 may move downward. The second exhaust/movement hole 72c, the second upward movement hole 72a, and the second downward movement hole 72b are provided to have the same or similar shapes as those of the first exhaust/movement hole 71c, the first upward movement hole 71a, and the first downward movement hole 71b to support the same or similar functions thereof.

The cool air regulating hole 73 may be provided to discharge the cool air generated by the air conditioner 230 to the outside. This cool air regulating hole 73 may be removed according to an intention of a manufacturer. Alternatively, the cool air regulating hole 73 may be opened or closed according to a control of a control unit of the cooling device 100 or may be manually opened and closed by a user. For example, when the fans 210 and 220 and the air conditioner 230 are operated at the same time, the cool air regulating hole 73 may be closed. When only the air conditioner 230 is operated, the cool air regulating hole 73 may be opened.

The first fan 210 may be disposed on one side of the cooling device 100, for example, on one side of an upper portion thereof. The first fan 210 includes a fan including a plurality of blades, a protector for surrounding the fan, a support for moving the fan and a head including the protector forward or backward while supporting the fan and the head, a power source for supplying power to the head, and a motor for rotating the fan using the power source. The head of the first fan 210 may protrude outward from the case 101 through the first exhaust/movement hole 71c provided in the case 101 according to the control and may be rotated within a specified angle range in at least one of right, left, upward, and downward directions according to the control of the control unit or the operation of the user. In addition, intensity of the wind generated by the first fan 210 may be controlled according to the control of the control unit or the operation of user. In addition, a rotation speed as well as a rotation direction of the first fan 210 may be controlled according to the control of the control unit or the operation of the user.

The second fan 220 may be provided to be the same as or similar to the first fan 210. The second fan 220 may be disposed below the first fan 210. As another example, the second fan 220 may have a lower output than the first fan 210 or may have a wind strength different from that of the first fan 210. The second fan 220 may have an output lower than the motor output of the first fan 210. Similar to the first fan 210, the head of the second fan 220 may protrude outward from the case 101 through the second exhaust/movement hole 72c provided in the case 101 according to the control of the control unit and may be rotated within a specified angle range in at least one of right, left, upward, and downward directions according to the control of the control unit or the operation of the user. In addition, intensity of the wind generated by the second fan 220 may be controlled according to the control of the control unit or the operation of user. In addition, a rotation speed as well as a rotation direction of the second fan 220 may be controlled according to the control of the control unit or the operation of the user.

The air conditioner 230 may include an outdoor unit to generate cool air or a pipe that may be connected to the outdoor unit and may cool and discharge air suctioned from the outdoor unit. The cool air discharged from the air conditioner 230 may circulate inside the case 101 and then move to at least one of the first area in which the first fan 210 is disposed and the second area in which the second fan 220 is disposed.

In addition, the cooling device 100 may include a first pipe 231 through which the cool air generated by the air conditioner 230 is guided to the first device placement hole 71 and a second pipe 232 through which the cool air generated by the air conditioner 230 is guided to the second device placement hole 72.

One side of the first pipe 231 may be connected to a discharge port through which the cool air is discharged in the structure of the air conditioner 230, and the other side of the first pipe 231 may be disposed at the first device placement hole 71 in which the first fan 210 is disposed. Accordingly, the cool air discharged from the air conditioner 230 may move to the rear (for example, a rear surface area in which air flowing in a fan direction of the first fan 210 is disposed) of the first fan 210 along the first pipe 231.

Similar to the first pipe 231, one side of the second pipe 232 may be connected to a discharge port through which the cool air is discharged in the structure of the air conditioner 230, and the other side of the second pipe 232 may be disposed at the second device placement hole 72 in which the second fan 220 is disposed. The cool air discharged from the air conditioner 230 may move to the rear (for example, a rear surface area in which air flowing in a fan direction of the second fan 220 is disposed) of the second fan 220. Additionally, the first pipe 231 and the second pipe 232 may each include a valve or a cover which may control the discharge of the cool air. The valve and the cover may be opened or closed according to the control unit of the cooling device 100 or the operation of the user.

Meanwhile, in the above descriptions, the structure in which two fans are disposed in the cooling device 100 is described, but the present invention is not limited thereto. For example, the cooling device 100 may include three or more fans or may include only one fan and one air conditioner.

As described above, in the cooling device 100 of the present invention, the plurality of fans 210 and 220 having the same output or different outputs and the air conditioner 230 are used to control an ambient temperature, the cool air generated by the air conditioner 230 is forcibly convected using the fans 210 and 220, and thus, it is possible to effectively circulate the ambient air and perform the cooling. In particular, in the cooling device 100 of the present invention, the output of at least one of the fans 210 and 220 or the outputs of the fans 210 and 220 are adjusted according to the setting value, and thus, it is possible to more quickly circulate the cool air generated by the air conditioner 230. Alternatively, in the cooling device 100 of the present invention, the outputs of the fans 210 and 220 are adjusted according to the output of the cool air of the air conditioner 230. Accordingly, by rapidly moving the cool air to a specific area or slowly moving the cool air to a specific area, it is possible to adjust an arrival time of the cool air for a specific area. As a result, the adjustment of the arrival time of the cool air may provide a temperature effect for the specific area. In addition, in the cooling device 100 of the present invention, the fans 210 and 220 are provided to rotate in at least one of upward, downward, right, and left directions, and thus, it is possible to move the cool air generated by the air conditioner 230 in various directions. Moreover, in the present invention, the plurality of fans 210 and 220 and the air conditioner 230 are disposed in a single compact case 101, and thus, it is possible to maximize space utilization.

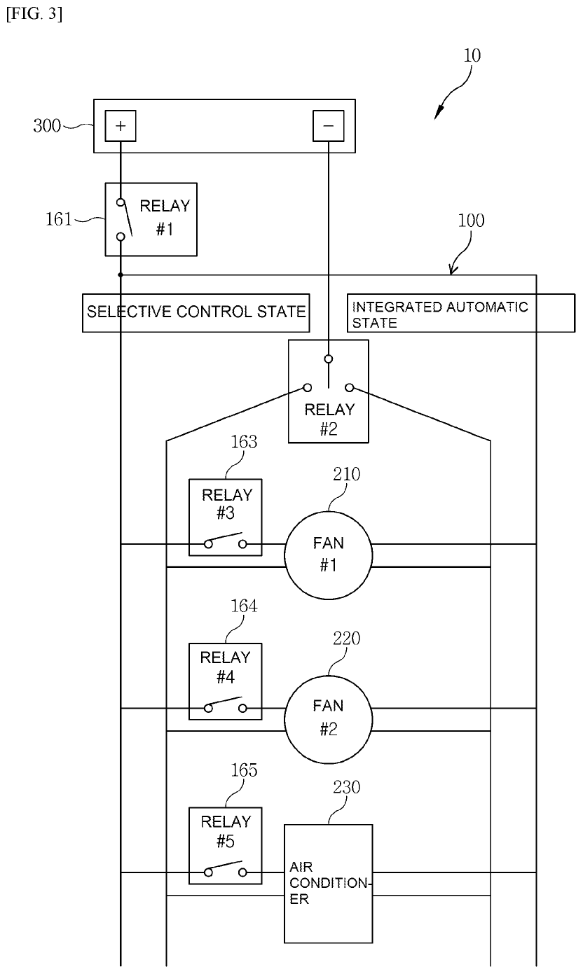

FIG. 3 is a diagram illustrating an example of a power control structure of the cooling device according to one embodiment of the present invention.

Referring to FIG. 3, a power control structure 10 of the cooling device of the present invention may include a power source 300 and the cooling device 100 connected to the power source 300, and the cooling device 100 includes the first fan 210, the second fan 220, and the air conditioner 230 and may include a first relay 161, a second relay 162, a third relay 163, a fourth relay 164, and a fifth relay 165. Additionally or alternatively, the cooling device 100 may include the case 101 described with reference to FIGS. 1 and 2. The first fan 210, the second fan 220, and the air conditioner 230 illustrated in FIG. 3 may have substantially the same structures as those of the first fan 210, the second fan 220, and the air conditioner 230 described in FIGS. 1 and 2.

The first relay 161 may control supply of the main power source 300. For example, the first relay 161 may cut off or connect the power source 300 from or to the cooling device 100 according to the control unit of the cooling device 100 or the operation of the user.

The second relay 162 may support selection of any one of a selection control state and an integrated automatic state. For example, the second relay 162 in the selection control state may be set to independently turn the fans 210 and 220 and the air conditioner 230 on or off. For example, the second relay 162 in the integrated automatic state may be set to simultaneously turn the fans 210 and 220 and the air conditioner 230 on or off.

The third relay 163 may control turning-on or turning-off of the first fan 210. For example, the third relay 163 maintains a turn-on state when the second relay 162 is in the integrated automatic state, and when the second relay 162 is in the selective control state, the third relay 163 may receive a signal from the control unit of the cooling device 100 or an operation signal of the user to turn the first fan 210 on or off. Alternatively, the third relay 163 may control the first fan 210 to be turned on or off even when the second relay 162 is in the integrated automatic state.

The fourth relay 164 may control turning-on or turning-off of the second fan 220. For example, the fourth relay 164 maintains a turn-on state when the second relay 162 is in the integrated automatic state, and when the second relay 162 is in the selective control state, the third relay 163 may receive the signal from the control unit of the cooling device 100 or the operation signal of the user to turn the second fan 220 on or off. Alternatively, the fourth relay 164 may control the second fan 220 to be turned on or off even when the second relay 162 is in the integrated automatic state.

The fifth relay 165 may control turning-on or turning-off of the air conditioner 230. For example, the fifth relay 165 maintains a turn-on state when the second relay 162 is in the integrated automatic state, and when the second relay 162 is in the selective control state, the fifth relay 165 may receive a signal from the control unit of the cooling device 100 or the operation signal of the user to turn the air conditioner 230 on or off. Alternatively, the fifth relay 165 may control the first fan 210 to be turned on or off even when the air conditioner 230 is in the integrated automatic state.

As described above, the cooling device 100 according to one embodiment of the present invention may use the first to fifth relays 161, 162, 163, 164, and 165 to provide the function of controlling at least one of the fans 210 and 220 and the air conditioner 230 individually or simultaneously. For example, according to the operation, the first to fifth relays 161, 162, 163, 164, and 165 may turn on only the fans 210 and 220, turn on the first fan 210 and the air conditioner 230, turn on the second fan 220 and the air conditioner 230, or turn the first and second fans 210 and 220 and the air conditioner 230 on or off. For example, the first to fifth relays 161, 162, 163, 164, and 165 described above may be controlled by a wired or wireless communication method using a manual switch, a receiving device controlled by a signal received from a remote control, a device controlled by a signal received from Internet of Things (IoT) devices, or the like.

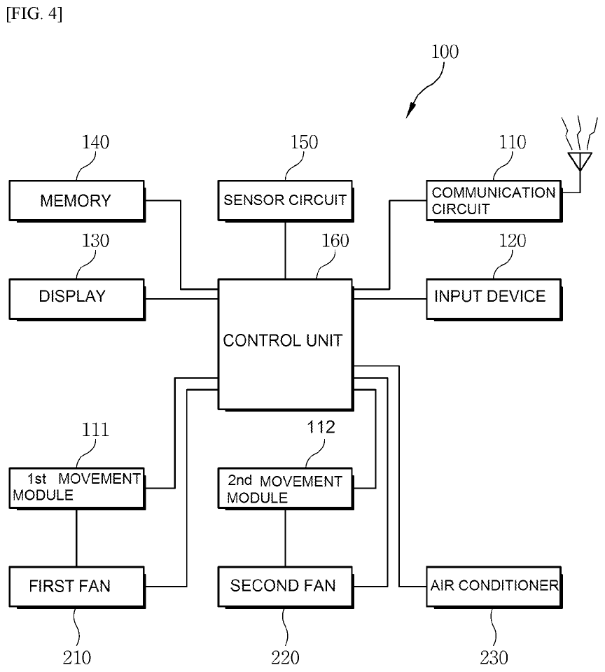

FIG. 4 is a diagram illustrating an example of a configuration of the cooling device according to one embodiment of the present invention.

Referring to FIG. 4, the cooling device 100 of the present invention may include the first fan 210, the second fan 220, the air conditioner 230, a first movement module 111 related to movement of the first fan 210, and a second movement module 112 related to movement of the second fan 220. In addition, the cooling device 100 includes a communication circuit 110, an input device 120, a display 130, a memory 140, a sensor circuit 150, and a control unit 160 to operate or control at least one of the first fan 210, the second fan 220, and the air conditioner 230. Additionally or alternatively, the control unit 160 may control the first to fifth relays 161, 162, 163, 164, and 165 described in FIG. 3. In this regard, in the cooling device 100, a control circuit or wires for controlling the first to fifth relays 161, 162, 163, 164, and 165 may be disposed in the control unit 160.

The first fan 210, the second fan 220, and the air conditioner 230 may have configurations which are substantially the same as or similar to those of the first fan 210, the second fan 220, and the air conditioner 230 described in FIGS. 1 to 3.

The first movement module 111 may perform a rotational movement, a linear movement, and a vertical movement of the first fan 210 according to at least one of automatic and manual manners. For example, the first movement module 111 may support a linear movement such that the head of the first fan 210 may protrude through a front surface of the case 101 or the protruding head of the first fan 210 may move inward of the case 101. Alternatively, the first movement module 111 may support the protruding head of the first fan 210 to rotate vertically or horizontally. Alternatively, the first movement module 111 may support the head of the first fan 210 to move up and down linearly by a predetermined height upward or a predetermined depth downward. Here, at least one of the rotational movement, linear movement, and vertical movement may be performed by the operation of the user. Alternatively, at least one of the rotational movement, linear movement, and vertical movement may be performed according to a mechanical method. In this regard, the first movement module 111 may include at least one of at least one gear, a shaft, a belt, and a bearing.

The second movement module 112 may perform at least one of a rotational movement, a linear movement, and a vertical movement of the second fan 220 according to automatic and manual manners. The second movement module 112 may be provided similarly or identically to the first movement module 111 described above.

The communication circuit 110 may form a communication channel for a communication function of the cooling device 100. Alternatively, the communication circuit 110 may receive a signal transmitted from a remote control or the like and transmit the received signal to the control unit 160. The communication circuit 110 may include at least one of a short-range communication circuit for supporting communication according to a short-range communication method (for example, Bluetooth, infrared rays, or the like), a mobile communication circuit or a Wi-Fi communication circuit for supporting communication according to a long-distance communication method (for example, mobile communication, Internet communication, or the like). The communication circuit 110 may receive a signal for turning-on or turning-off of the cooling device 100 and adjusting the setting value and transmit the signal to the control unit 160.

The input device 120 may include at least one physical button or touch panel which may manually operate at least one of the fans 210 and 220 and the air conditioner 230. For example, the input device 120 may include at least one of the first to third input devices 121, 122, and 123 described in FIG. 1. Meanwhile, when the display 130 includes a touch function and provides an operation interface which may operate at least one of the fans 210 and 220 and the air conditioner 230 included in the cooling device 100, the input device 120 may be omitted from the configuration of the cooling device 100. As another example, the input device 120 may be provided in the form of an operation button which may operate the first to fifth relays 161, 162, 163, 164, and 165.

The display 130 may output at least one screen related to the operation of the cooling device 100. For example, the display 130 may indicate a turn-on/turn-off state or a standby state of the cooling device 100. The display 130 may indicate a setting value set for the cooling device 100 and a current state (for example, at least one of ambient temperature, humidity, and illuminance of the cooling device 100). In addition, the display 130 may output an operation interface related to the manual operation of the cooling device 100. As another example, the display 130 may display information on operating states of the fans 210 and 220 and the air conditioner 230. For example, the display 130 may display wind strength, rotation states, operation reservation times, or the like of the fans 210 and 220. Alternatively, the display 130 may display a set temperature or humidity of the air conditioner 230, a current temperature, a current humidity, an intensity of the air conditioner 230, a mode of the air conditioner 230, or the like. In addition, the display 130 may provide various driving modes of the cooling device 100. For example, the display 130 may display a rapid mode in which both the fans 210 and 220 and the air conditioner 230 are operated, a maintenance mode in which at least one of the fans 210 and 220 is operated, an idle or sleep mode in which the fans 210 and 220 and the air conditioner 230 are intermittently operated, or the like.

The memory 140 may store at least one program or related data related to the operation of the cooling device 100. For example, the memory 140 may store various modes related to the operation of the cooling device 100 and the setting values of the fans 210 and 220 and the air conditioner 230 to be operated according to each mode.

The sensor circuit 150 may detect at least one of ambient temperature, ambient humidity, and ambient illuminance of the cooling device 100. In this regard, the sensor circuit 150 may include a temperature sensor, a humidity sensor, an illuminance sensor, or the like.

The control unit 160 may control turning-on/turning-off of components disposed in the cooling device 100, the operations of the components, or the like. For example, when the control unit 160 receives an input signal related to the operation of the cooling device 100 through the input device 120 or the communication circuit 110, the control unit may control the operation of at least one of the fans 210 and 220 and the air conditioner 230 according to the input signal. When power is supplied from the power source 300 to the cooling device 100, the control unit 160 may control the operating states of the fans 210 and 220 and the air conditioner 230 according to the temperature and humidity control of the air conditioner. Alternatively, when a surrounding situation reaches the setting value of the user while the control unit 160 is in a standby state, the control unit 160 may control the operating state of at least one of the fans 210 and 220 and the air conditioner 230. Alternatively, after the control unit 160 checks the ambient temperature and humidity, and according to a difference from the setting value, the control unit 160 may automatically adjust the operation state (for example, turning-on of the devices, the wind strength, rotation direction, and rotation speed of the fans 210 and 220, a degree of coldness of the cool air of the air conditioner 230, or the like).

For example, in order to reach the temperature of the setting value, the control unit 160 simultaneously turns on the fans 210 and 220 and the air conditioner 230 to be operated, and then when the temperature of the setting value is reached, the control unit 160 may turn off the air conditioner 230 and maintain the turn-on states of the fans 210 and 220. In this operation, the control unit 160 may adjust at least one of the wind strength, the rotation directions, and the rotation speeds of the fans 210 and 220, and a type of the fan to be turned on, according to the situation. As described above, in the control unit 160 of the cooling device 100 of the present invention, the plurality of fans 210 and 220 and the air conditioner 230 may be located in one case 101 to improve design elements and space utilization, and the control unit 160 may selectively operate the fans 210 and 220 and the air conditioner 230 during cooling to save electricity and improve temperature control performance. In addition, in the control unit 160, the sensor circuit 150 may be attached to one side of the case 101 or one side of the fans 210 and 220 to obtain temperature/humidity information, and it is possible to continuously manage the cooling effect while saving energy by automatically adjusting the wind strength, rotation degree, rotation speed, or the like according to the obtained information.

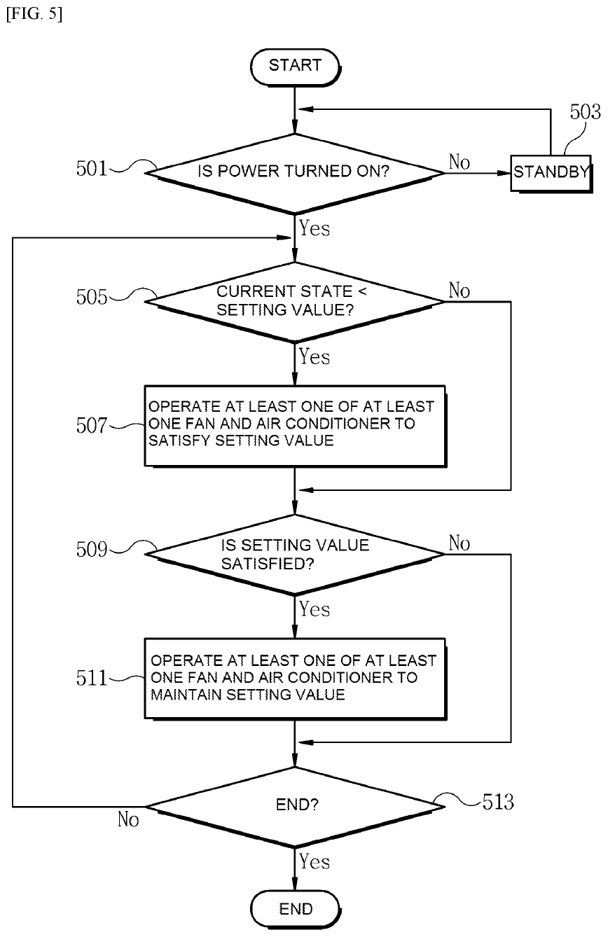

FIG. 5 is a view illustrating an example of a cooling device operating method according to one embodiment of the present invention.

Referring to FIG. 5, in the cooling device operating method according to one embodiment of the present invention, the control unit 160 of the cooling device 100 may check whether the power source is turned on in operation 501.

When the power source is not turned on in operation 501, the control unit 160 may be in a standby state in operation 503. For example, the standby state may include a state in which power is supplied from the power source to the fans 210 and 220 and the air conditioner 230 but the fans 210 and 220 and the air conditioner 230 are not operated. Alternatively, the standby state may include a state in which the second to fifth relays 162, 163, 164, and 165 are turned off while power is supplied from the power source to only the first relay 161.

When an input signal (for example, an operation signal from a manual operation, a remote control, an IoT (mobile) device, or the like) for requesting turning-on of the power source is received from the outside in operation 501, the control unit 160 may check whether a value of a current state (for example, at least one of ambient temperature, ambient humidity, and ambient illuminance) is less than or equal to a setting value. The setting value may be a value set immediately in the cooling device 100 or a value (for example, set temperature) input by a current operation of the user.

When a current state value (for example, ambient temperature) is less than or equal to a setting value (for example, set temperature), the control unit 160 may operate at least one of at least one fan (for example, at least one of the fans 210 and 220) and the air conditioner 230 to satisfy the setting value in operation 507. Alternatively, the control unit 160 may control the operating state of at least one of the fans 210 and 220 and the air conditioner 230 according to a difference between the current state value and the setting value. For example, when the difference between the current state value and the setting value is a first size, the control unit 160 turns on all of the fans 210 and 220 and the air conditioner 230 to perform an operation at a first cool air temperature and a first wind strength. Alternatively, when the difference between the current state value and the setting value is a second size smaller than the first size, the control unit 160 may turn on all of the fans 210 and 220 and the air conditioner 230 to perform an operation at a second cool air temperature higher than the first cool air temperature (or a temperature lower than the first cool air temperature) and a second wind intensity smaller than the first air intensity. Alternatively, when the difference between the current state value and the setting value is the second size smaller than the first size, the control unit 160 may turn on the first fan 210 (or the second fan 220) of the fans 210 and 220 and the air conditioner 230 to perform an operation at the first cool air temperature and the first wind strength. Alternatively, when the difference between the current state value and the setting value is the second size smaller than the first size, the control unit 160 may turn on only the fans 210 and 220 to perform an operation at the first wind strength. Additionally, the control unit 160 may differently adjust at least one of the rotation directions, rotation angles, and rotation speeds of the fans 210 and 220 according to the difference between the current state value and the setting value.

Next, the control unit 160 may check whether the setting value is satisfied in operation 509. When the setting value is satisfied, the control unit 160 may operate at least one of at least one fan and the air conditioner in operation 511 to maintain the setting value. For example, the control unit 160 may turn on only one of the fans 210 and 220 to perform the operation at a specified wind speed. That is, the control unit 160 may perform the operation using relatively many devices with a relatively high output until reaching the setting value and may perform the operation using relatively few devices with a relatively small output during a maintenance period after reaching the setting value.

Next, the control unit 160 may check whether an event related to termination of the operation of the cooling device 100 occurs in operation 513. When there is no event related to a separate operation termination, the control unit 160 returns to the operation before operation 505 and performs the processes from operation S505 again.

Meanwhile, in operation 505, when the current state value satisfies the setting value or is the setting value or more, the control unit 160 may return to the operation before operation 509 and proceed to operation 511 according to the satisfaction of the setting value. In addition, when the setting value is not satisfied in operation 509, for example, when the current ambient temperature is higher than the set temperature, the control unit 160 may skip operation 511 and return to the operation before operation 505 and perform the operations from operation 505 again.

In the above-described cooling device operating method of the present invention, when the difference between the ambient temperature (or temperature and humidity) and the setting value is a first value and becomes a second value smaller than the first value according to the temperature control, it is possible to select fewer devices than previously operating devices or control the operation with less output than the previously operating devices. Alternatively, the control unit 160 may control fewer devices to operate with less output.

As another example, in the cooling device operating method, when an ultra-power saving mode is selected according to the operation of the user, only some devices are operated, or the interval between the operation time of one fan and the air conditioner 230 and the operation time of one fan may be adjusted. For example, the control unit 160 of the cooling device 100 may set the operation time of the fan and air conditioner 230 to 10 minutes, and after 10 minutes, may turn off the air conditioner 230 and maintain the output of the fan or adjust the output of the fan with less output. In the cooling device operating method, a combination of operated devices and output levels of operated devices may be set differently according to a mode selected according to the operation of the user, for example, a sleep mode, an idle mode, an operation mode, or the like.

As described above, the specification includes details of a number of specific implementations, but the details should not be construed as limiting to any invention or a scope of the claims, but rather, the details are to be understood as a description of features that may be peculiar to a particular embodiment of a particular invention.

Further, although the operations are depicted in the drawings in a specific order, it should not be understood that the operations should be performed in the specific order or sequential order illustrated should be performed or all illustrated operations should be performed in order to obtain a desired result. In certain cases, multitasking and parallel processing may be advantageous. In addition, separation of the various system components of the above-described embodiments should not be understood as requiring the separation in all embodiments, and it should be understood that the program components and systems described may generally be integrated together as a single software product or packaged in multiple software products.

The descriptions of the present invention present the best mode of the present invention and provide an example for describing the present invention and allowing a person skilled in the art to make and use the present invention. The specification described in this way does not limit the present invention to the specific terms presented. Therefore, although the present invention is described in detail with reference to the above-described examples, a person skilled in the art may apply alternations, changes, and modifications to the examples within a scope which does not depart from the scope of the present invention.

Accordingly, the scope of the present invention should not be determined by the described embodiments but should be determined by claims.

### INDUSTRIAL APPLICABILITY

According to the present invention, the present invention provides a cooling device including a fan and an air conditioner. Therefore, it is possible to maximize energy saving during a cooling control while optimizing space utilization, and it is possible to provide various economic effects through the power saving while providing effective temperature control.

1. A cooling device comprising:
a case;
a first fan and a second fan at least partially disposed in the case;
an air conditioner disposed inside the case;
relays configured to individually or simultaneously turn the first fan, the second fan, and the air conditioner on or off;
an input device configured to generate an input signal related to operations of the first fan, the second fan, and the air conditioner; and
a control unit configured to control the relays,
wherein the relays include:
a first relay connected to an external power source;
a second relay disposed to simultaneously or selectively control the fans and the air conditioner;
a third relay configured to independently control the first fan;
a fourth relay configured to independently control the second fan; and
a fifth relay configured to independently control the air conditioner.

2. A cooling device comprising:
a case;
at least one fan at least partially disposed in the case;
an air conditioner disposed inside the case;
an input device configured to generate an input signal related to operations of the at least one fan and the air conditioner;
a sensor circuit configured to detect a surrounding environment; and
a control unit configured to control the operations of the at least one fan and the air conditioner,
wherein the control unit simultaneously operates the at least one fan and the air conditioner or selectively operates some of the fans and the air conditioner according to a difference between a current surrounding state value obtained based on the sensor circuit and a setting value set in advance.

3. The cooling device of claim 2, wherein the case includes a device placement hole in which a head including a blade of the fan is disposed, and
the cooling device further includes a movement module configured to move the fan so that at least a portion of the head of the fan protrudes or is drawn into the case through the device placement hole.

4. The cooling device of claim 3, wherein the movement module operates the fan so that the head of the fan rotates within a specified rotation angle range in at least one direction of upward, downward, right, and left directions or the fan linearly moves in a vertical direction.

5. The cooling device of claim 2, wherein the case further includes a cool air regulating hole through which cool air generated by the air conditioner is exhausted to an outside of the case or flows inside the case according to a control.

6. The cooling device of claim 2, further comprising at least one pipe through which cool air generated by the air conditioner moves to a region in which the at least one fan is disposed.

7. An operation method of a cooling device including at least one fan at least partially disposed in a case and an air conditioner disposed inside the case, the operation method comprising:
receiving an input signal related to operations of the at least one fan and the air conditioner;
checking a current surrounding state value based on a sensor unit; and
simultaneously or partially operating the at least one fan and the air conditioner according to a difference between the checked current surrounding state value and a setting value set in advance.

8. The operation method of claim 7, wherein the operating includes simultaneously operating the at least one fan and the air conditioner when the difference between the current surrounding state value and the setting value set in advance is a first size, and operating some of the at least one fan and the air conditioner when the difference between the current surrounding state value and the setting value set in advance is a second size smaller than the first size.

9. The operation method of claim 8, wherein the operating includes controlling outputs of the at least one fan and the air conditioner to be smaller than before when the difference between the current surrounding state value obtained based on the sensor circuit and the setting value set in advance is the second size smaller than the first size.

10. The operation method of claim 7, further comprising at least one of operating devices of which a number is smaller than the number of devices including the at least one fan and the air conditioner and operating outputs of the devices including the at least one fan and the air conditioner with a smaller output than before when a surrounding state value is changed according to operations of the least one fan and the air conditioner.
